(19) United States
(12) Patent Application Publication
(10) Pub. No.: US 2015/0056585 A1
(43) Pub. Date: Feb. 26, 2015

(54) SYSTEM AND METHOD MONITORING AND CHARACTERIZING MANUAL WELDING OPERATIONS

(71) Applicants: Paul Christopher Boulware, Columbus, OH (US); Christopher C. Conrardy, Columbus, OH (US); Douglas A. Clark, Columbus, OH (US); M. William Forquer, Columbus, OH (US)

(72) Inventors: Paul Christopher Boulware, Columbus, OH (US); Christopher C. Conrardy, Columbus, OH (US); Douglas A. Clark, Columbus, OH (US); M. William Forquer, Columbus, OH (US)

(73) Assignee: EWI, INC., Columbus, OH (US)

(21) Appl. No.: 14/293,826

(22) Filed: Jun. 2, 2014

Related U.S. Application Data
(63) Continuation-in-part of application No. 13/543,240, filed on Jul. 6, 2012.

(51) Int. Cl. G09B 19/24

(52) U.S. Cl. CPC G09B 19/24
USPC 434/234

(57) ABSTRACT

A system and method for monitoring manual welding that includes a welding system that further includes hardware and software components for gathering and processing data in real time, wherein the data is derived from an actual welding exercise conducted by a welder; providing the system with part information, process variable control targets, and acceptability limits; selecting a part to be welded from the part information; indicating a production task to be completed on the part; performing the indicated production task; providing real-time feedback to the welder performing the task; evaluating the quality of the welder's performance of the task based on the process variable control targets and acceptability limits; if necessary, requiring remedial action with regard to the quality of the performance of the task; and storing data gathered from the evaluation of the performance of the task.

### BACKGROUND OF THE INVENTION

The described invention relates in general to a system for characterizing manual welding operations, and more specifically to a system for providing useful information to a welding trainee by capturing, processing, and presenting in a viewable format, data generated by the welding trainee in manually executing an actual weld in real time.

The manufacturing industry's desire for efficient and economical welder training has been a well-documented topic over the past decade as the realization of a severe shortage of skilled welders is becoming alarmingly evident in today's factories, shipyards, and construction sites. A rapidly retiring workforce, combined with the slow pace of traditional instructor-based welder training has been the impetus for the development of more effective training technologies. Innovations which allow for the accelerated training of the manual dexterity skills specific to welding, along with the expeditious indoctrination of arc welding fundamentals are becoming a necessity. The characterization and training system disclosed herein addresses this vital need for improved welder training and enables the monitoring of manual welding processes to ensure the processes are within permissible limits necessary to meet industry-wide quality requirements. To date, the majority of welding processes are performed manually, yet the field is lacking practical commercially available tools to track the performance of these manual processes. Thus, there is an ongoing need for an effective system for training welders to properly execute various types of welds under various conditions.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first system and method for monitoring and characterizing manual welding is provided. This system and method includes providing a welding system that further includes both hardware and software components, wherein the hardware and software are operative to gather and process data in real time, and wherein the data is derived from an actual welding exercise conducted by a welder; providing the system with part information, process variable control targets, and acceptability limits; selecting a part to be welded from the part information; indicating a production task to be completed on the selected part; performing the indicated production task; optionally, providing real-time feedback to the welder performing the indicated production task; evaluating the quality of the welder's performance of the indicated production task based on the process variable control targets and acceptability limits; optionally, requiring remedial action with regard to the quality of the performance of the indicated production task; and storing data gathered from the evaluation of the performance of the indicated production task.

In accordance with another one aspect of the present invention, a second system and method for monitoring and characterizing manual welding is provided. This system and method includes providing a welding system that further includes both hardware and software components, wherein the hardware and software are operative to gather and process data in real time, and wherein the data is derived from an actual welding exercise conducted by a welder; providing the system with part information, process variable control targets, and acceptability limits; selecting a part to be welded from the part information; indicating a production task to be completed on the selected part; performing the indicated production task; providing real-time feedback to the welder performing the indicated production task; evaluating the quality of the welder's performance of the indicated production task based on the process variable control targets and acceptability limits; requiring remedial action with regard to the quality of the performance of the indicated production task, if necessary; and storing data gathered from the evaluation of the performance of the indicated production task.

In accordance with still another aspect of the present invention, a third system and method for monitoring and characterizing manual welding is provided. This system and method includes providing a welding system that further includes both hardware and software components, wherein the hardware and software are operative to gather and process data in real time, and wherein the data is derived from an actual welding exercise conducted by a welder; providing the system with part information, process variable control targets, and acceptability limits, wherein the part information further includes part variables and task variables; selecting a part to be welded from the part information; indicating a production task to be completed on the selected part, wherein the production task to be completed on the part further includes form variables and execution variables; performing the indicated production task; providing real-time feedback to the welder performing the indicated production task, wherein real-time feedback further includes automated audio feedback or augmented reality weld rendering; evaluating the quality of the welder's performance of the indicated production task based on the process variable control targets and acceptability limits, and wherein the quality evaluation is further based on performance measurements, numerical quality simulations; direct quality measurements; or combinations thereof; requiring remedial action with regard to the quality of the performance of the indicated production task, wherein the remedial action is either a disparate production task or a request to complete an active indicated production task; and storing data gathered from the evaluation of the performance of the indicated production task.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a flow diagram of the monitoring system and methodology of an exemplary embodiment of the system and method of the present invention;

FIG. 2 is a flow diagram of the automated audio feedback component of the system and methodology of the present invention; and

FIG. 3 is a flow diagram of the augmented reality component of the system and methodology of the present invention.

### DETAILED DESCRIPTION OF THE INVENTION

Exemplary embodiments of the present invention are now described with reference to the Figures. Reference numerals are used throughout the detailed description to refer to the various elements and structures. In other instances, well-known structures and devices are shown in block diagram form for purposes of simplifying the description. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

In some embodiments, the present invention incorporates and expands upon the technology disclosed in U.S. patent application Ser. No. 13/543,240, which is incorporated by reference herein, in its entirety for all purposes. U.S. patent application Ser. No. 13/543,240 discloses a system for characterizing manual welding operations, and more specifically a system for providing useful information to a welding trainee by capturing, processing, and presenting in a viewable format, data generated by the welding trainee in manually executing an actual weld in real time. More specifically, the system disclosed in U.S. patent application Ser. No. 13/543,240 includes a data generating component; a data capturing component; and a data processing component. The data generating component further includes a fixture, wherein the geometric characteristics of the fixture are predetermined; a workpiece adapted to be mounted on the fixture, wherein the workpiece includes at least one joint to be welded, and wherein the vector extending along the joint to be welded defines an operation path; at least one calibration device, wherein each calibration device further includes at least two point markers integral therewith, and wherein the geometric relationship between the point markers and the operation path is predetermined; and a welding tool, wherein the welding tool is operative to form a weld at the joint to be welded, wherein the welding tool defines a tool point and a tool vector, and wherein the welding tool further includes a target attached to the welding tool, wherein the target further includes a plurality of point markers mounted thereon in a predetermined pattern, and wherein the predetermined pattern of point markers is operative to define a rigid body. The data capturing component further includes an imaging system for capturing images of the point markers. The data processing component is operative to receive information from the data capturing component and then calculate the position and orientation of the operation path relative to the three-dimensional space viewable by the imaging system; the position of the tool point and orientation of the tool vector relative to the rigid body; and the position of the tool point and orientation of the tool vector relative to the operation path. With regard to the system components and operational principles discussed above (i.e., how the data which characterizes the welding operation is obtained), the present invention provides means for taking advantage of the acquired data in the production monitoring realm and provides various methods for utilizing manual welding characterization data for monitoring various aspects of production.

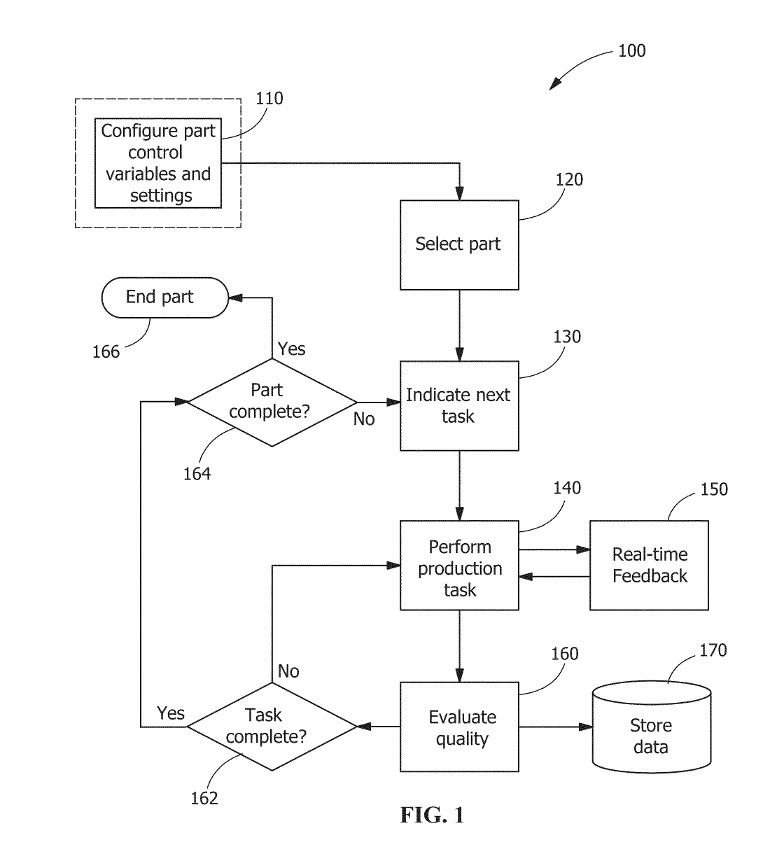

FIG. 1 provides a flow chart that details system 100 and an associated method in accordance with the present invention for integrating manual welding performance measurements into the context of production monitoring. From initially configuring a system to measuring production quality, the methodology described herein includes means for taking advantage of manual tool manipulation and process measurements to better monitor production quality and outcome. As shown in FIG. 1, the initial step in the process is to configure the system inputs at step 110. More specifically, this step includes providing system 100 with part information and process variable control targets and acceptability limits. Production monitoring can commence once the configuration information is present for at least one part. Step 120 includes selecting a part, which is the first step in the monitoring aspect of the methodology. Selection of the part initializes the monitoring settings, and initializes production of the part to the first production task at step 130. The active task is performed with or without real-time feedback at step 150 on the performance at step 140. The performance is then evaluated post-process to identify any possible quality concerns at step 160 and the corresponding data is stored at step 170. If remedial action is required this is indicated to the user in the form of either a disparate production task or a request to complete the active task. If the task is deemed complete the system shifts to the next production task. Once the final production task is completed the part is deemed finished and user may move on to the next part (see decision steps 162 and 164 and ending step 166 in FIG. 1).

As indicated above, step 110 includes configuring the system inputs. The purpose of this step is to populate the system with the parts that will be monitored and their corresponding characteristics, which include both part variables and task variables as detailed in Tables 1 and 2, below.

TABLE 1
List of Parts Variables.
Part Variables
Part name or ID
Solid model
Number of tasks (e.g. welds, seals, part attachments, etc.)

TABLE 2
List of Task Variables.
Task Variables
Task name or ID
Operation path or locations
Operation direction (if neccessary)
Task specific variables*

For each type of task, a set of variables specific to that task are then entered into the system at step 110. For example, a welding task will include both form and execution variables which define the task. Tables 3 and 4, which appear below, provide examples of these types of variables.

TABLE 3
Examples of Form Variables.

| Form Variables | Typical Values |
|---|---|
| Process | SMAW, GMAW, FCAW, GTAW |
| Joint Type | Fillet, Lap, Groove |
| Position | Flat, Horizontal, Vertical, Overhead |
| Material | Steel, Aluminum, Titanium |
| Thickness | 0.25, 0.5, 1 [in] |
| Electrode Type | ER70S-6 |
| Root Gap | 0.03, 0.06, 0.125 [in] |
| Root Landing | 0.03, 0.125, 0.25 [in] |
| Included Angle | 10, 15, 20 [°] |

TABLE 4
Examples of Execution Variables.

| Execution Variables | Typical Values |
|---|---|
| Polarity | DCEP, DCEN |
| Work Angle | 45 ± 5 [°] |
| Travel Angle | 5 ± 5 [°] |
| Arc Length | 0.5 ± 0.125 [in] |
| Travel Speed | 10 ± 2 [ipm] |
| Tool Placement | 0.0 ± 0.1 [in] |
| Current | 180 ± 20 [A] |
| Voltage | 22 ± 2 [V] |
| Weld Length | 8 ± 0.25 [in] |
| Weld Size | 0.25 ± 0.025 [in] |

The variables listed in Tables 3 and 4 provide the user with information that both describes the task and defines the proper manner of execution. Additionally, the configuration function provides the means to enter tool definitions into the system. The tool definitions allow for the system to integrate tool position into its working coordinate system, which allows for tool position and orientation to be compared with the task operation path, thereby permitting acquisition of tool manipulation variables. Each task which requires a tool must have one definition before production monitoring can be executed. These tools are then called up by the system when user initiates a task which requires the tool.

With reference again to FIG. 1, the remaining portion of the monitoring methodology of this invention takes the user through the production of a part and the inconspicuous monitoring of performance in the manufacturing of that part. Before monitoring can begin, a part is selected at step 120 when the library of parts configured in step 110 is accessed by a user of the system. The system then auto-populates with all of the information relative to the selected part. This information includes a list of tasks for completion of the part, a graphical representation of the part, highlighted tasks on the part, an indication of the first task to be carried out, and any other relevant information. An indication of the next task then occurs at step 130. The active task is indicated to the user graphically and all pertinent information is provided to the user to carrying out completion of the task. This information varies from task to task. For example, if the task is to place a weld two components of the part together, the system will provide the user with all of the information listed in Tables 3 and 4. The start and stop locations will be clearly identified to the user. Additionally, periphery information will be highlighted, which may include special fixturing, tools, possible pitfalls, etc. Performance of a production task occurs at step 140. Once the user has digested the necessary information to carry out the task, production on the task is started. Again, this aspect of the invention varies task by task. Again using the welding example, completion of the task includes depositing a weld in the proper location, with the proper speed, proper technique, proper process variables, etc. Real-time feedback is provided at step 150. During the performance of a production task, a number of real-time feedback variables are available to help the user stay within the defined quality control window. For welding tasks, these feedback mechanisms include the Automated Audio Feedback and Augmented Reality Weld Rendering.

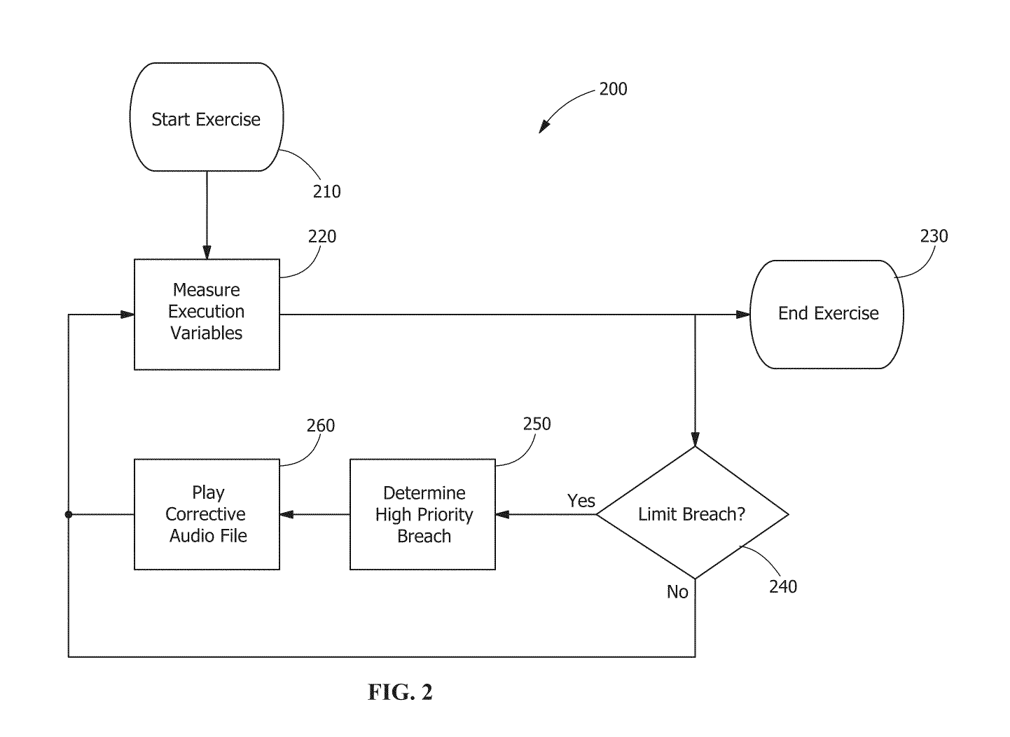

Automated audio feedback includes a real-time feedback mechanism which provides feedback to the user through various automated voice commands. Prerecorded files are played depending which variables are outside of the control limits. FIG. 2 provides a flow diagram of automated audio feedback component 200, wherein the exercise begins at 210; execution variables are measured at step 220; the exercise may end at step 230 or if a limit is breached at decision point 240 a determination of a high priority breach is made at step 250; and a corrective audio file is played at step 260. As shown in Table 5, below, a hierarchy is established by which high-priority variables take precedence over lower priority variables. At any given data interpretation frame, only one feedback command is executed based on the priority hierarchy (e.g. tool placement takes precedence over tool angle, which takes precedence over travel speed, etc.)

TABLE 5
Automated audio coaching hierarchy.

| Rank | Variable |
|---|---|
| 1 | Tool Placement |
| 2 | Tool Offset |
| 3 | Travel Speed |
| 4 | Work Angle |
| 5 | Travel Angle |

Commands are direction-based, meaning that the commands coach the user into the direction of compliance (e.g., if the performance is breaching a lower boundary, the commands will coach the trainee to increase the given variable).

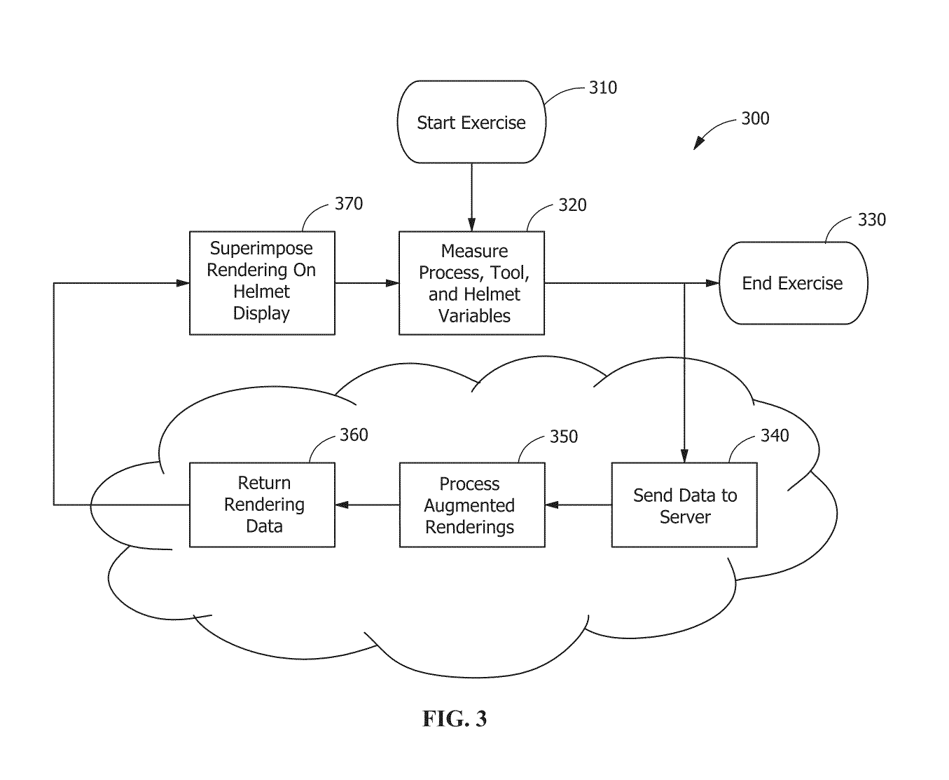

Augmented reality provides real-time feedback during task performance. In welding tasks, sensors provide real-time position and orientation values of both the welding helmet and the welding tool in addition to processing data to a cloud-based server. This server performs processor intensive rendering calculations and/or finite element calculations, feeding back to the local system image data to be superimposed over the welder's view of the welding joint. FIG. 3 provides a flow diagram of the sensor and data flow for augmented reality component 300, wherein the exercise begins at 310; process, tool, and helmet variables are measured at step 320; the exercise may end at 330 or data may be sent to the server at step 340; augmented renderings are processed at step 350; rendering data is returned at step 360; and the rendering is superimposed on the helmet display at step 370. For welding, the superimposed imagery may include the following features: highlights of the welding joint location; target and actual weld pool shape and position (this is the first step is learning to manipulate a weld pool); target and actual arc placement within the joint; target and actual tool angles; target and actual tool offset; target and actual travel speed; live indication of defect formation along the weld; or combinations thereof. A cloud-based server may be utilized to manage the data for augmented reality feedback. Specifically, the processing power of the server may be utilized to take low data count information (i.e., process, tool, and helmet) in, to output image renderings that can be immediately superimposed on the user's see-through display. FIG. 3 also illustrates the remote data processing functionality of this invention. Once the performance of a task is complete, the system evaluates the quality of performance at step 160 (see FIG. 1). This evaluation can be done (i) in terms of performance measurements (e.g., tool manipulation and process variables within control limits); and/or (ii) in terms of numerical quality simulations (e.g., probability of defect formation), and/or (iii) with direct quality measurements.

Performance-based evaluation uses direct performance measurements compared to preset control limits to make a quality determination along the operation path. For example, in welding tasks, control limits will be set for each of the execution variables listed in Table 4. If any of the measured variables fall outside of the control limits at a certain location along the weld, that location is flagged as a potential quality issue. The control limit breach type is included in the flag. Thus, is important to properly set the control limits to align with quality producing indications. The limits must be tight enough to detect quality issues when they arise, but loose enough to avoid the generation of false positives. Additionally, many applications in welding require control limits to be variable along the length of the weld. In other words, the control limit set (i.e., allowable maximum and minimum window) may change as a function of position along the operation path. This is typical for curved operation paths or operation paths which turn corners. Generating variable control limit sets can be tedious for long and circuitous operation paths and to facilitate the process, these sets can be generated by teaching the system with a set of “good” welds and “bad” welds. In configuration, the user calibrates the control set by performing the production task a number of times and assigning each performance a good or bad value. The system then automatically generation a position-based set of control limits for the task using a standard deviations from the mean of the good welds.

Simulated quality evaluation using tool manipulation and process measurements to calculate probabilities of defect formation as a function of position along the operation path. For welding tasks, the output can be a probability of formation of sub-surface defects (e.g., porosity, lack of fusion, lack of penetration, etc.) or surface defects (e.g., undercut, underfill, poor toe angles, etc.), or material defects (generation of an unwanted phase or constituent, high distortion, crack generation). These values are generated by way of numerical simulation where the form and execution variables act as the inputs and defect generation is the output. Like performance-based evaluation these results can be shown graphically to the user in the form of highlights on the part solid model.

Directly measured quality evaluation is basically identical to simulated quality evaluation except that the generation of the quality data is taken from sensor tools which physically measure for the presence of defects. These tools can vary from sub-surface inspection tools (e.g. ultrasonic, eddy current, x-ray inspection) to surface tools (e.g., laser scanner, machine vision, dye penetrant, etc.). Like the other forms of evaluation, any indication of unacceptable performance is highlighted graphically to the user in the form of highlights on a solid model of the part. If performance of a task has been compromised though a performance-based evaluation or a quality-based evaluation, the user interface will provide a remedial action. This can be as simple as a flag to inspect to instructing the user to rework the task. With reference to FIG. 1, once a task is deemed complete at decision point 164 the user interface moves on to the next performance task at 130. Once all performance tasks are complete, the part is deemed complete at end point 166. Acquired performance data for each production task is stored in either a local or remote server at 170. This data can then be used for statistical process control, quality validation for legal matters, and for other purposes.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) A method for monitoring and characterizing manual welding, comprising;
(a) providing a welding system, wherein the welding system further includes both hardware and software components, wherein the hardware and software are operative to gather and process data in real time, and wherein the data is derived from an actual welding exercise conducted by a welder;
(b) providing the system with part information, process variable control targets, and acceptability limits;
(c) selecting a part to be welded from the part information;
(d) indicating a production task to be completed on the selected part;
(e) performing the indicated production task;
(f) optionally, providing real-time feedback to the welder performing the indicated production task;
(g) evaluating the quality of the welder's performance of the indicated production task based on the process variable control targets and acceptability limits;
(h) optionally, requiring remedial action with regard to the quality of the performance of the indicated production task; and
(i) storing data gathered from the evaluation of the performance of the indicated production task.

2) The method of claim 1, wherein the welding system further includes:
(a) a data generating component, wherein the data generating component further includes:
(i) a fixture, wherein the geometric characteristics of the fixture are predetermined;
(ii) a workpiece adapted to be mounted on the fixture, wherein the workpiece includes at least one joint to be welded, and wherein the vector extending along the joint to be welded defines an operation path;
(iii) at least one calibration device, wherein each calibration device further includes at least two point markers integral therewith, and wherein the geometric relationship between the point markers and the operation path is predetermined; and
(iv) a welding tool, wherein the welding tool is operative to form a weld at the joint to be welded, wherein the welding tool defines a tool point and a tool vector, and wherein the welding tool further includes a target attached to the welding tool, wherein the target further includes a plurality of point markers mounted thereon in a predetermined pattern, and wherein the predetermined pattern of point markers is operative to define a rigid body; and
(b) a data capturing component, wherein the data capturing component further includes an imaging system for capturing images of the point markers; and
(c) a data processing component, wherein the data processing component is operative to receive information from the data capturing component and then calculate:
(i) the position and orientation of the operation path relative to the three-dimensional space viewable by the imaging system;
(ii) the position of the tool point and orientation of the tool vector relative to the rigid body; and
(iii) the position of the tool point and orientation of the tool vector relative to the operation path.

3) The method of claim 1, wherein the welding system is in communication with at least one cloud-based server.

4) The method of claim 1, wherein the part information further includes part variables and task variables; wherein the part variables further include part name or identification, at least one solid model of the part, and a list of tasks to be completed on the part; and wherein the task variables further include task name or identification, operation path or locations, operation directions, and other task specific variables.

5) The method of claim 1, wherein the production task to be completed on the part further includes form variables and execution variables; wherein the form variables further include process type, joint type, position, material, thickness, electrode type, root gap, root landing, and included angle; and wherein the execution variables further include polarity, work angle, travel angle, arc length, travel speed, tool placement, current, voltage, weld length, and weld size.

6) The method of claim 1, wherein the real-time feedback further includes automated audio feedback, and wherein automated audio feedback provides real-time feedback to the welder through various automated voice commands.

7) The method of claim 1, wherein the real-time feedback further includes augmented reality weld rendering, wherein augmented reality weld rendering further includes the use of sensors that provide real-time position and orientation values of both a welding helmet and a welding tool in addition to processing data to a cloud-based server, wherein the server performs rendering calculations or finite element calculations, and wherein image data is generated based on these calculations and is superimposed over a welder's view of a welding joint during performing the indicated production task.

8) The method of claim 2, wherein evaluating the quality of the welder's performance of the indicated production task is performance based, and wherein the performance-based evaluation uses direct performance measurements compared to preset control limits to make a quality determination along the operation path.

9) The method of claim 2, wherein evaluating the quality of the welder's performance of the indicated production task is based on numerical quality simulations, and wherein numerical quality simulations use tool manipulation and process measurements to calculate probabilities of defect formation as a function of position along the operation path.

10) The method of claim 2, wherein evaluating the quality of the welder's performance of the indicated production task is based on direct quality measurements, and wherein direct quality measurements are taken from sensor tools which physically measure for the presence of weld defects.

11) The method of claim 1, wherein the remedial action is either a disparate production task or a request to complete an active indicated production task.

12) A method for monitoring and characterizing manual welding, comprising;
(a) providing a welding system, wherein the welding system further includes both hardware and software components, wherein the hardware and software are operative to gather and process data in real time, and wherein the data is derived from an actual welding exercise conducted by a welder;
(b) providing the system with part information, process variable control targets, and acceptability limits;
(c) selecting a part to be welded from the part information;
(d) indicating a production task to be completed on the selected part;
(e) performing the indicated production task;
(f) providing real-time feedback to the welder performing the indicated production task;
(g) evaluating the quality of the welder's performance of the indicated production task based on the process variable control targets and acceptability limits;
(h) requiring remedial action with regard to the quality of the performance of the indicated production task; and
(i) storing data gathered from the evaluation of the performance of the indicated production task.

13) The method of claim 12, wherein the welding system further includes:
(a) a data generating component, wherein the data generating component further includes:
(i) a fixture, wherein the geometric characteristics of the fixture are predetermined;
(ii) a workpiece adapted to be mounted on the fixture, wherein the workpiece includes at least one joint to be welded, and wherein the vector extending along the joint to be welded defines an operation path;
(iii) at least one calibration device, wherein each calibration device further includes at least two point markers integral therewith, and wherein the geometric relationship between the point markers and the operation path is predetermined; and
(iv) a welding tool, wherein the welding tool is operative to form a weld at the joint to be welded, wherein the welding tool defines a tool point and a tool vector, and wherein the welding tool further includes a target attached to the welding tool, wherein the target further includes a plurality of point markers mounted thereon in a predetermined pattern, and wherein the predetermined pattern of point markers is operative to define a rigid body; and
(b) a data capturing component, wherein the data capturing component further includes an imaging system for capturing images of the point markers; and
(c) a data processing component, wherein the data processing component is operative to receive information from the data capturing component and then calculate:
(i) the position and orientation of the operation path relative to the three-dimensional space viewable by the imaging system;
(ii) the position of the tool point and orientation of the tool vector relative to the rigid body; and
(iii) the position of the tool point and orientation of the tool vector relative to the operation path.

14) The method of claim 12, wherein the welding system is in communication with at least one cloud-based server.

15) The method of claim 12, wherein the part information further includes part variables and task variables; wherein the part variables further include part name or identification, at least one solid model of the part, and a list of tasks to be completed on the part; and wherein the task variables further include task name or identification, operation path or locations, operation directions, and other task specific variables.

16) The method of claim 12, wherein the production task to be completed on the part further includes form variables and execution variables; wherein the form variables further include process type, joint type, position, material, thickness, electrode type, root gap, root landing, and included angle; and wherein the execution variables further include polarity, work angle, travel angle, arc length, travel speed, tool placement, current, voltage, weld length, and weld size.

17) The method of claim 12, wherein the real-time feedback further includes automated audio feedback, and wherein automated audio feedback provides real-time feedback to the welder through various automated voice commands.

18) The method of claim 12, wherein the real-time feedback further includes augmented reality weld rendering, wherein augmented reality weld rendering further includes the use of sensors that provide real-time position and orientation values of both a welding helmet and a welding tool in addition to processing data to a cloud-based server, wherein the server performs rendering calculations or finite element calculations, and wherein image data is generated based on these calculations and is superimposed over a welder's view of a welding joint during performing the indicated production task.

19) The method of claim 13, wherein evaluating the quality of the welder's performance of the indicated production task is performance based, and wherein the performance-based evaluation uses direct performance measurements compared to preset control limits to make a quality determination along the operation path.

20) The method of claim 13, wherein evaluating the quality of the welder's performance of the indicated production task is based on numerical quality simulations, and wherein numerical quality simulations use tool manipulation and process measurements to calculate probabilities of defect formation as a function of position along the operation path.

21) The method of claim 13, wherein evaluating the quality of the welder's performance of the indicated production task is based on direct quality measurements, and wherein direct quality measurements are taken from sensor tools which physically measure for the presence of weld defects.

22) The method of claim 12, wherein the remedial action is either a disparate production task or a request to complete an active indicated production task.

23) A method for monitoring and characterizing manual welding, comprising;
(a) providing a welding system, wherein the welding system further includes both hardware and software components, wherein the hardware and software are operative to gather and process data in real time, and wherein the data is derived from an actual welding exercise conducted by a welder;
(b) providing the system with part information, process variable control targets, and acceptability limits, wherein the part information further includes part variables and task variables;
(c) selecting a part to be welded from the part information;
(d) indicating a production task to be completed on the selected part, wherein the production task to be completed on the part further includes form variables and execution variables;
(e) performing the indicated production task;
(f) providing real-time feedback to the welder performing the indicated production task, wherein real-time feedback further includes automated audio feedback or augmented reality weld rendering;
(g) evaluating the quality of the welder's performance of the indicated production task based on the process variable control targets and acceptability limits, and wherein the quality evaluation is further based on performance measurements, numerical quality simulations; direct quality measurements; or combinations thereof;
(h) requiring remedial action with regard to the quality of the performance of the indicated production task, wherein the remedial action is either a disparate production task or a request to complete an active indicated production task; and
(i) storing data gathered from the evaluation of the performance of the indicated production task.

24) The method of claim 23, wherein the welding system further includes:
(a) a data generating component, wherein the data generating component further includes:
(i) a fixture, wherein the geometric characteristics of the fixture are predetermined;
(ii) a workpiece adapted to be mounted on the fixture, wherein the workpiece includes at least one joint to be welded, and wherein the vector extending along the joint to be welded defines an operation path;
(iii) at least one calibration device, wherein each calibration device further includes at least two point markers integral therewith, and wherein the geometric relationship between the point markers and the operation path is predetermined; and
(iv) a welding tool, wherein the welding tool is operative to form a weld at the joint to be welded, wherein the welding tool defines a tool point and a tool vector, and wherein the welding tool further includes a target attached to the welding tool, wherein the target further includes a plurality of point markers mounted thereon in a predetermined pattern, and wherein the predetermined pattern of point markers is operative to define a rigid body; and
(b) a data capturing component, wherein the data capturing component further includes an imaging system for capturing images of the point markers; and
(c) a data processing component, wherein the data processing component is operative to receive information from the data capturing component and then calculate:
(i) the position and orientation of the operation path relative to the three-dimensional space viewable by the imaging system;
(ii) the position of the tool point and orientation of the tool vector relative to the rigid body; and
(iii) the position of the tool point and orientation of the tool vector relative to the operation path.

25) The method of claim 23, wherein the welding system is in communication with at least one cloud-based server.

26) The method of claim 23, wherein the part variables further include part name or identification, at least one solid model of the part, and a list of tasks to be completed on the part; and wherein the task variables further include task name or identification, operation path or locations, operation directions, and other task specific variables.

27) The method of claim 23, wherein the form variables further include process type, joint type, position, material, thickness, electrode type, root gap, root landing, and included angle; and wherein the execution variables further include polarity, work angle, travel angle, arc length, travel speed, tool placement, current, voltage, weld length, and weld size.

28) The method of claim 23, wherein automated audio feedback provides real-time feedback to the welder through various automated voice commands.

29) The method of claim 23, wherein augmented reality weld rendering further includes the use of sensors that provide real-time position and orientation values of both a welding helmet and a welding tool in addition to processing data to a cloud-based server, wherein the server performs rendering calculations or finite element calculations, and wherein image data is generated based on these calculations and is superimposed over a welder's view of a welding joint during performing the indicated production task.

30) The method of claim 24, wherein the performance-based evaluation uses direct performance measurements compared to preset control limits to make a quality determination along the operation path.

31) The method of claim 24, wherein numerical quality simulations use tool manipulation and process measurements to calculate probabilities of defect formation as a function of position along the operation path.

32) The method of claim 24, wherein direct quality measurements are taken from sensor tools which physically measure for the presence of weld defects.
